(19) United States
(12) Patent Application Publication
(10) Pub. No.: US 2006/0215810 A1
(43) Pub. Date: Sep. 28, 2006

(54) Fluorescent X-ray analyzer, fluorescent X-ray analysis method, and fluorescent X-ray analysis program

(75) Inventor: Yasuhiro Usui, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/192,140

(22) Filed: Jul. 29, 2005

(30) Foreign Application Priority Data
Mar. 22, 2005 (JP) 2005-080991

(51) Int. Cl. G01N 23/223; G01T 1/36

(52) U.S. Cl. 378/44

(57) ABSTRACT

The present invention has been made to obtain a fluorescent X-ray analyzer and the like capable of easily performing analysis of a sample including materials in the form of a multiple layer in the depth direction of the sample at low cost without a need of a skilled technique and time. A fluorescent X-ray analysis method according to the present invention that performs analysis of materials in a sample including different materials in the form of a multiple layer analyzes the materials by irradiating the sample with an X-ray to detect an fluorescent X-ray; estimates a processing amount for the sample based on a result of the analysis; and applies processing to the sample based on the processing amount estimated in the processing amount estimation step.

### BACKGROUND OF THE INVENTION

1. Field of the Invention

The present invention relates to a fluorescent X-ray analyzer, a fluorescent X-ray analysis method, and a fluorescent X-ray analysis program that performs analysis of materials in a sample including different materials in the form of a multiple layer.

2. Description of the Related Art

In the field of elementary analysis, various analyzers have been proposed depending on an object to be analyzed and required accuracy. Among these, a general-purpose fluorescent X-ray analyzer is known (refer to, for example, Patent Document 1: Jpn. Pat. Appln. Laid-Open Publication No. 63-177047) as an analyzer capable of easily analyzing a material surface at short times.

The general-purpose fluorescent X-ray analyzer has the following features:
(1) X-irradiating a material to be analyzed and performing quantitative analysis and qualitative analysis based on the intensity of the fluorescent X-ray generated from the material.
(2) Capable of measuring an area diameter of about 1 to 10 mm in a single analysis operation, and an area to be measured is limited to a surface area.
(3) Being influenced by base materials in the case of analyzing the surface of a part made of a plurality of materials in the form of a multiple layer.
(4) Capable of measuring in the atmosphere, having good operability and being inexpensive.

As described above, the capability of the general-purpose fluorescent X-ray analyzer is limited to analysis of a surface area; whereas an Auger Electron spectroscopy (AES), Electron Spectroscopy for chemical Analysis (ESCA), and FIB (Focused Ion Beam System) are known as analyzers that utilize ion sputtering to process the sample in the depth direction thereof to enable analysis of an interior area (refer to, for example, Patent Document 2: Jpn. Pat. Appln. Laid-Open Publication No. 2003-75374).

Recently, an approach to the exclusion of harmful element such as lead or cadmium contained in a product becomes active as a green action, and the analysis of these harmful elements for materials and parts becomes indispensable. In particular, there is a need to develop a simple and effective analyzer to be used for shipping inspection in parts manufacturers or receiving inspection in end-product manufacturers.

However, although conventional fluorescent X-ray analyzers can analyze a surface material for the parts (in particular, electronic parts) made of a plurality of materials, they have difficulty in analyzing the interior materials.

In order to cope with this problem, it is possible to adopt a method that previously applies processing such as cutting to a sample to allow respective regions in the sample to be exposed to outside and individually analyses the respective regions using a fluorescent X-ray analyzer, as shown (a) in FIG. 11. However, time and skilled processing technique are required since a plurality of samples must be prepared.

In order to analyze the interior materials, it is possible to adopt the abovementioned analyzer that utilizes ion sputtering to enable the analysis of a sample in depth direction thereof, as shown (b) in FIG. 11. However, the analyzer utilizing ion sputtering is very expensive and requires advanced techniques. Further, the process utilizing ion sputtering takes a lot of time in processing and cannot obtain even surface due to different etching rate between used materials.

### SUMMARY OF THE INVENTION

An object of the present invention is to provide a fluorescent X-ray analyzer, a fluorescent X-ray analysis method, and a fluorescent X-ray analysis program capable of performing analysis of a sample made of materials in the form of a multiple layer in the depth direction of the sample with ease and at low cost without the need of a skilled technique and additional time.

To solve the above problem, according to a first aspect of the present invention, there is provided a fluorescent X-ray analyzer that performs analysis of materials in a sample including different materials in the form of a multiple layer, comprising: a processing section that applies processing to the sample; an analysis section that analyzes the materials by irradiating the sample with an X-ray to detect an fluorescent X-ray; a controller that estimates a processing amount for the sample based on an analysis result obtained by the analysis section and allows the processing section to apply processing to the sample based on the estimated processing amount.

Further, in the fluorescent X-ray analyzer according to the present invention, the controller detects fluorescent X-rays obtained at least from two layers stacked in the depth direction of the sample and estimates the processing amount based on the intensities of the detected fluorescent X-rays.

The fluorescent X-ray analyzer according to the present invention further comprises an imaging section that takes an image of the sample, wherein the controller determines the processing amount for the sample or processing position in the sample based on the image taken by the imaging section.

Further, the controller compares the sample images obtained before and after the processing for the sample to be processed by the processing section and determines the processing amount for the sample or processing position in the sample based on the comparison result.

Further, the controller acquires structure information related to the ample, compares the structure information and image taken by the imaging section, and determines the processing amount for the sample or processing position in the sample based on the comparison result.

The processing section includes a support section that supports the sample in a movable manner, and the controller allows the support section to move the sample when the processing section performs processing.

According to a second aspect of the present invention, there is provided a fluorescent X-ray analysis method that performs analysis of materials in a sample including different materials in the form of a multiple layer, comprising: an analysis step that analyzes the materials by irradiating the sample with an X-ray to detect an fluorescent X-ray; a processing amount estimation step that estimates a processing amount for the sample based on an analysis result obtained in the analysis step; and a processing step that applies processing to the sample based on the processing amount estimated in the processing amount estimation step.

In the fluorescent X-ray analysis method, the estimation step estimates the processing amount based on the intensities of the fluorescent X-rays obtained at least from two layers stacked in the depth direction of the sample.

The fluorescent X-ray analysis method further comprises: an imaging step that takes an image of the sample; and a determination step that determines the processing amount for the sample or processing position in the sample based on the image taken by the imaging step.

The determination step compares the sample images obtained before and after the processing for the sample to be processed in the processing step and determines the processing amount for the sample or processing position in the sample based on the comparison result.

Further, the determination step acquires structure information related to the sample, compares the structure information and image taken in the imaging step, and determines the processing amount for the sample or processing position in the sample based on the comparison result.

According to a third aspect of the present invention, there is provided a fluorescent X-ray analysis program allowing a computer to execute a fluorescent X-ray analysis method that performs analysis of materials in a sample including different materials in the form of a multiple layer, the program allowing the computer to execute: an analysis step that analyzes the materials by irradiating the sample with an X-ray to detect an fluorescent X-ray; a processing amount estimation step that estimates a processing amount for the sample based on an analysis result obtained in the analysis step; and a processing step that applies processing to the sample based on the processing amount estimated in the processing amount estimation step.

Further, in the present invention, the estimation step estimates the processing amount based on the intensities of the fluorescent X-rays obtained at least from two layers stacked in the depth direction of the sample.

The fluorescent X-ray analysis program further allows the computer to execute: an imaging step that takes an image of the sample; and a determination step that determines the processing amount for the sample or processing position in the sample based on the image taken by the imaging step.

The determination step compares the sample images obtained before and after the processing for the sample to be processed in the processing step and determines the processing amount for the sample or processing position in the sample based on the comparison result.

Further, the determination step acquires structure information related to the sample, compares the structure information and image taken in the imaging step, and determines the processing amount for the sample or processing position in the sample based on the comparison result.

As described above, the present invention allows analysis of materials to be performed while performing automatic processing based on a fluorescent X-ray analysis result. As a result, it is possible to easily performing analysis of a sample including materials in the form of a multiple layer in the depth direction of the sample at low cost without a need of a skilled technique and time.

### BRIEF DESCRIPTION OF THE DRAWINGS

FIG. 1 is a block diagram showing an entire configuration of an embodiment of the present invention;

FIG. 2 is a flowchart showing an entire operation of a controller;

FIG. 3 is a flowchart showing a determination operation on a processing amount or processing position in the embodiment of the present invention;

FIGS. 4A to 4M are conceptual views for explaining the determination process using an image;

FIG. 5 is a side view of a multi-layered sample;

FIGS. 6A to 6C are first views showing an estimation operation on the processing amount based on the analysis result;

FIGS. 7A to 7C are second views showing an estimation operation on the processing amount based on the analysis result;

FIGS. 8A to 8C are third views showing an estimation operation on the processing amount based on the analysis result;

FIG. 9 is an explanatory view showing a conventional processing operation;

FIG. 10 is an explanatory view showing a processing operation according to the embodiment of the present invention; and

FIG. 11 is a view showing a conventional technique.

### DETAILED DESCRIPTION OF THE PREFERRED EMBODIMENTS

An embodiment of the present invention will be described below with reference to the accompanying drawings.

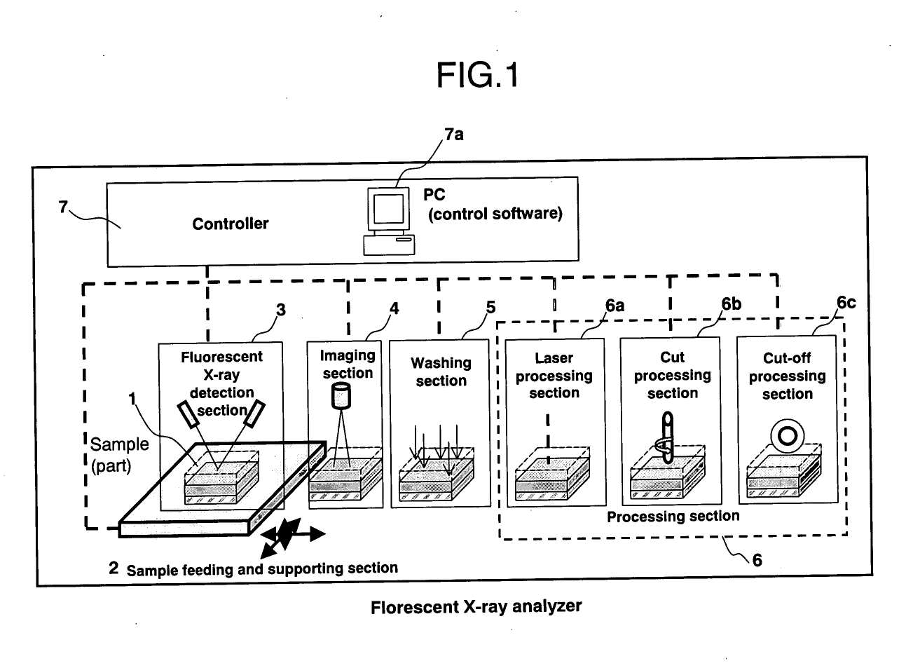

FIG. 1 is a block diagram showing an entire configuration of a fluorescent X-ray analyzer according to the present invention.

The fluorescent X-ray analyzer includes: a sample feeding and supporting section 2 that supports a part, which is a sample 1, and allows the sample 1 to move in a three-axis direction (x, y, z); a fluorescent X-ray detection section 3 that irradiates the sample (part) supported by the sample feeding and supporting section 2 with an X-ray to detect an fluorescent X-ray; an imaging section 4 that takes an image of the surface of the sample supported by the sample feeding and supporting section 2; a washing section 5 that washes the sample 1 supported by the sample feeding and supporting section 2; a processing section 6 that processes the sample 1 supported by the sample feeding and supporting section 2; and a controller 7 that is connected to the above sections 2 to 6 to control them and performs data analysis.

The controller 7 is constituted by a PC 7a that operates according to a predetermined program (fluorescent X-ray analysis program). The controller 7 performs data analysis of the fluorescent X-ray to serve as a fluorescent X-ray analysis section together with the fluorescent X-ray detection section 3. Further, the controller 7 collaborates with the imaging section 4 to thereby constitute an image recognition section. Each of the above configurations is one example among many, and respective functional sections may be configured by individual PCs. The controller 7 can acquire CAD data and controls the drive of the processing section 6 and sample feeding and supporting section 2 based on the CAD data, an analysis result from the fluorescent X-ray analysis section, and an image recognition result from the image recognition section.

The processing section 6 processes the surface of the sample to allow the materials in the depth direction of the sample surface to be exposed. The processing section 6 includes, for example, a laser processing section 6a, a cut processing section 6b, and a cut-off processing section 6c.

An operation of the controller, which corresponds to the operation of the embodiment of the present invention, will be described below.

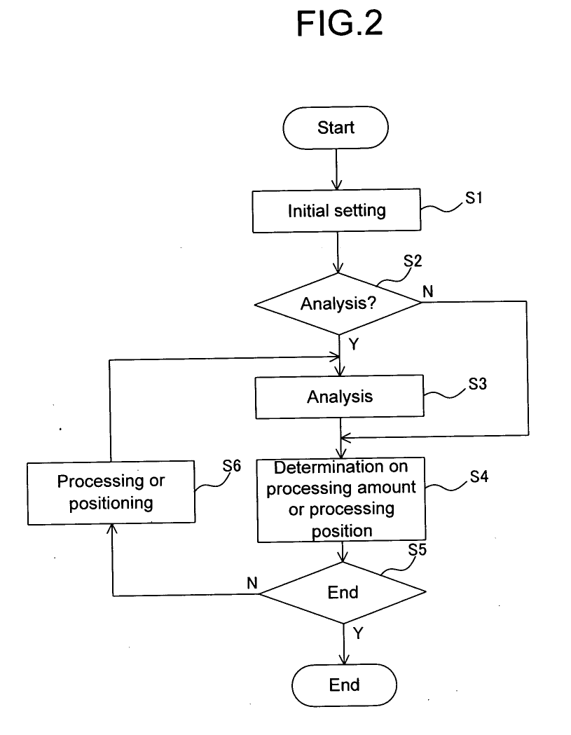

FIG. 2 is a flowchart of the entire operation of the controller. The controller performs an initial setting at the start time of analysis (step S1). Here, sample is set, and an analysis area, processing menu, and analysis menu are determined.

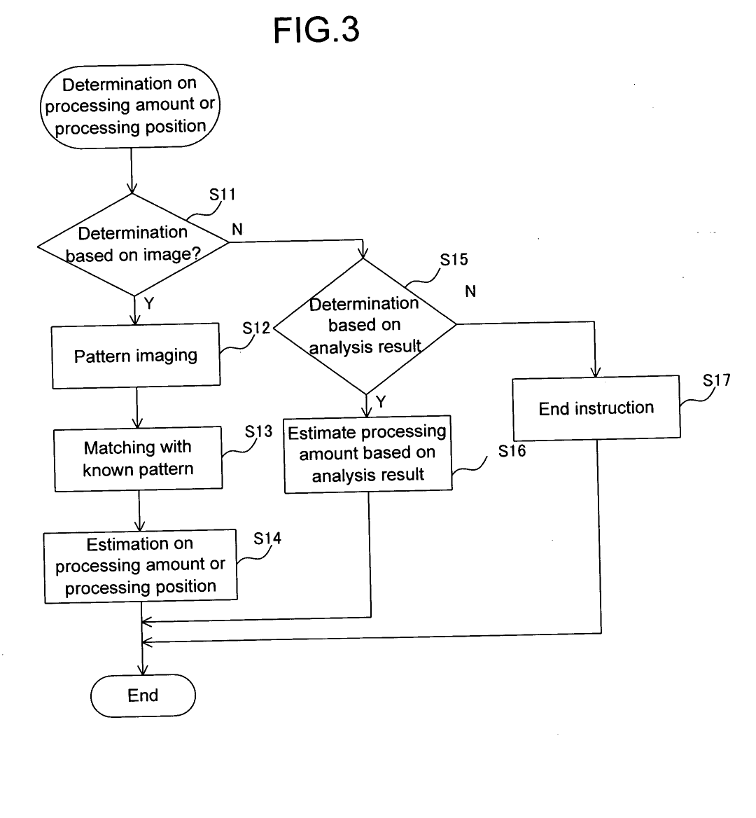

After completion of the initial setting, it is determined whether either of analysis or processing is to be performed next (step S2). This determination is made based on the menus set in the initial setting. When, for example, it has been determined that analysis is started from the sample surface, analysis is performed directly (step S3). After completion of the analysis, a processing amount or processing position is determined for the analysis of the next material layer (step S4). Details of this determination will be described later with reference to FIG. 3. After completion of the determination related to the processing amount or processing position, it is determined that whether the analysis process is ended or not (step S5). When it is determined that the analysis process is not ended, processing or positioning is performed based on the determination result (step S6).

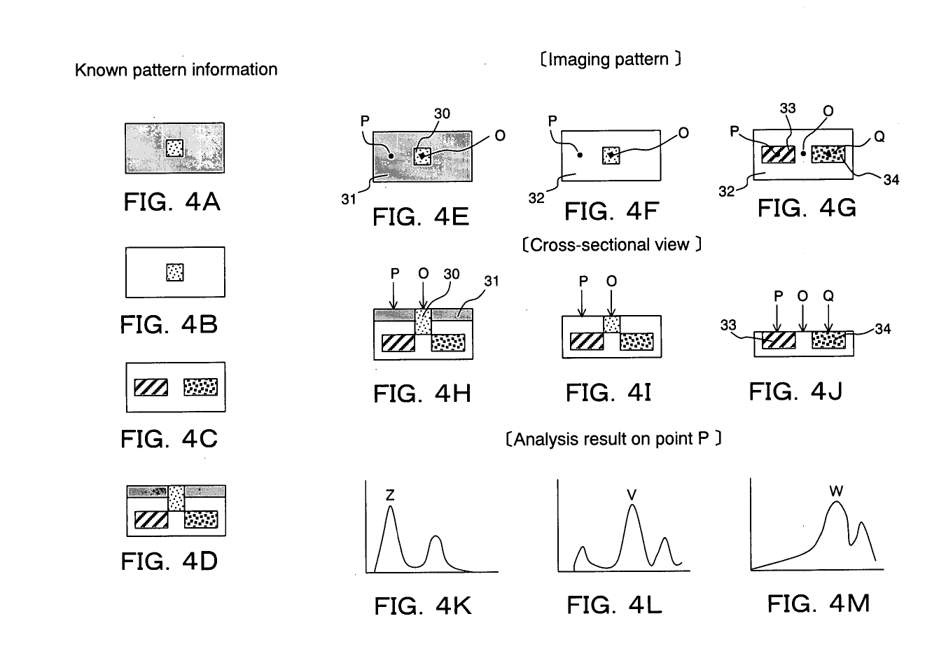

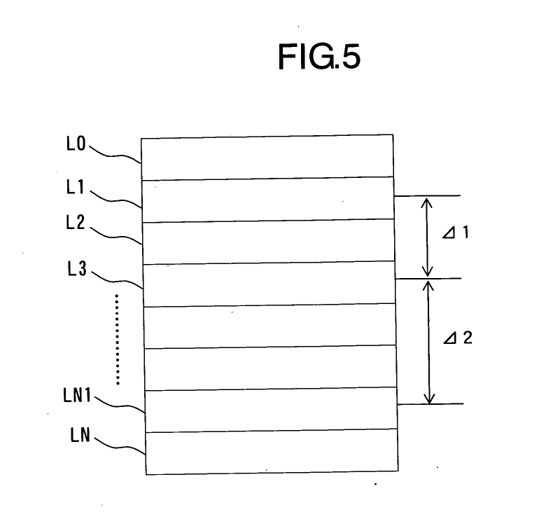

The determination operation (step S4) on the processing amount or processing position will be described with reference to FIGS. 3 to 8. FIG. 3 is a flowchart showing the determination operation on the processing amount or processing position. FIG. 4 is views showing a determination operation concept for a sample made of different three materials in the form of a multiple layer; FIGS. 4A to 4C are known plane patterns obtained from CAD data corresponding to respective layers; FIG. 4D is CAD data corresponding to cross-sectional pattern showing a known cross-sectional structure; FIGS. 4E to 4G are imaging patterns of respective layers; FIGS. 4H to 4J are cross-sectional views of the sample obtained through processing; and FIGS. 4K to 4M are views each showing a spectrum obtained as an example of the analysis result. FIG. 5 is a view showing the cross-section of the sample made of multi-layers L0 to LN.

In the determination operation on the processing amount or processing position, it is firstly determined whether either of determination based on an image or determination based on an analysis result is to be performed. This determination is made based on the menus set in the initial setting.

(Determination Based on Image)

In the determination operation on the processing position, for example, the controller 7 acquires known patterns (FIGS. 4A to 4D) based on CAD data and performs matching between the patterns and imaging patterns to control the position of the sample or X-ray irradiation position, thereby adjusting the analysis position. When, for example, positions of points P and Q are subjected to analysis in the imaging patterns FIGS. 4E to 4G, matching between the imaging patterns FIGS. 4E to 4G and known patterns FIGS. 4A to 4C are performed respectively to align a reference point (for example, point O), and thereby the point P can be determined with the reference point serving as a reference. Further, when the positions of points P and Q are subjected to analysis, it is possible to roughly determine respective processing areas and processing amounts based on the known patters (FIGS. 4A to 4D).

The multi-layered sample shown in FIG. 5 is used to describe the determination operation on the processing amount. Assume that the pattern of L3 can be acquired by processing after the pattern of L1 has been acquired. In this case, by comparing with the known pattern, it is possible to determine that the processing amount of this time is Δ1. This shows that it is only necessary to perform processing for the sample in the depth direction thereof by Δ2 when the material analysis of the layer LN-1 is performed. Thus, it is possible to increase processing efficiency.

Therefore, by setting the sample structure and its analysis position in the analysis menu, the controller 7 repeats the determination according to the analysis menu to automatically perform the analysis and processing number of times.

(Determination Based on Analysis Result)

The fluorescent X-ray has a predetermined transmittance, and thereby it is possible to perform analysis of the materials existed in the depth direction of a sample. This makes it possible to estimate the processing amount in the depth direction.

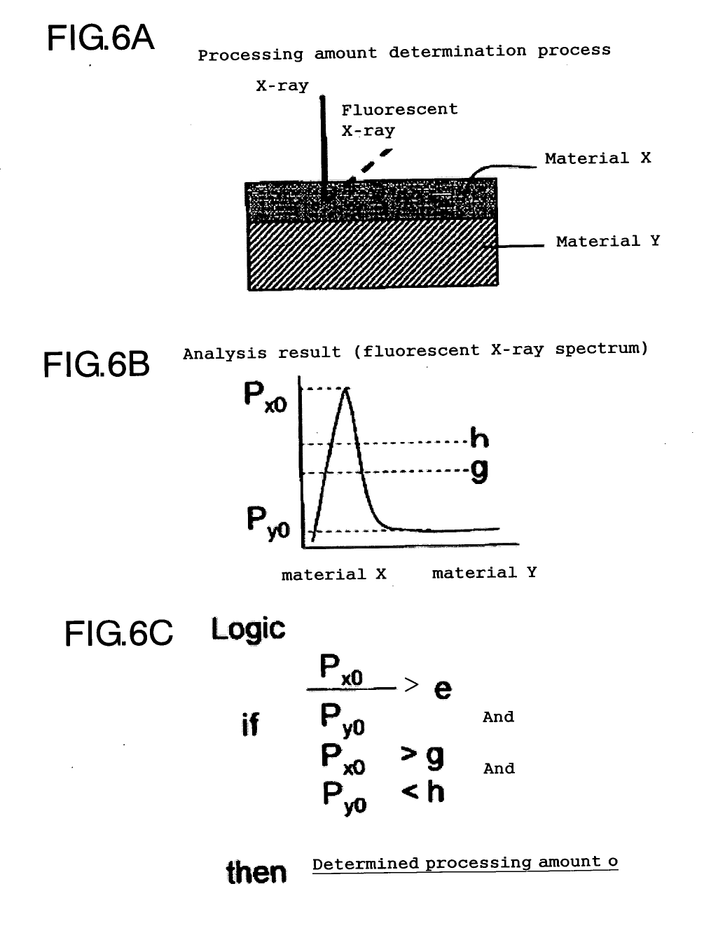

An example of the determination operation based on the analysis result will be described with reference to FIGS. 6 to 8. Assume that the surface layer of a sample in these drawings is made of material X, lower layer thereof is made of material Y, and analysis of the material Y is performed after completion of analysis of the material X. When the surface material X is a thick layer as shown in FIG. 6A, a fluorescent X-ray spectrum shown in FIG. 6B is obtained as an analysis result. Here, e, g, h, and i are set to predetermined specified values, and the subsequent processing amount for analyzing the material Y is to be estimated. When the logic shown in FIG. 6C is satisfied, the subsequent processing amount is estimated as o. That is, when analyzed intensity peak Px0 of the component of the material X is higher than specified value g and analyzed intensity peak Py0 of the component of the material Y is lower than specified value h, it is determined that the material X is still thick to determine the processing amount o.

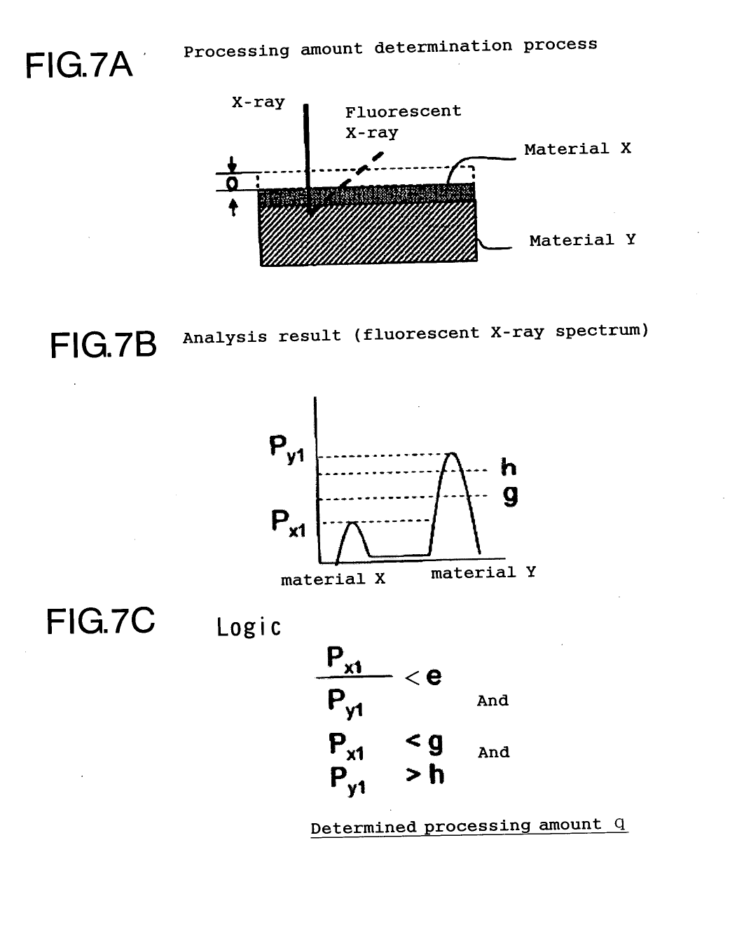

When the surface material becomes thinner by processing as shown in FIG. 7A, analyzed tendency as shown in FIG. 7B is obtained. In this case, when the logic shown in FIG. 7C is satisfied, the subsequent processing amount is estimated as q. That is, when analyzed intensity peak Px1 of the component of the material X is lower than specified value g and analyzed intensity peak Py1 of the component of the material Y is higher than specified value h, it is determined that the material X becomes thinner to determine the processing amount q.

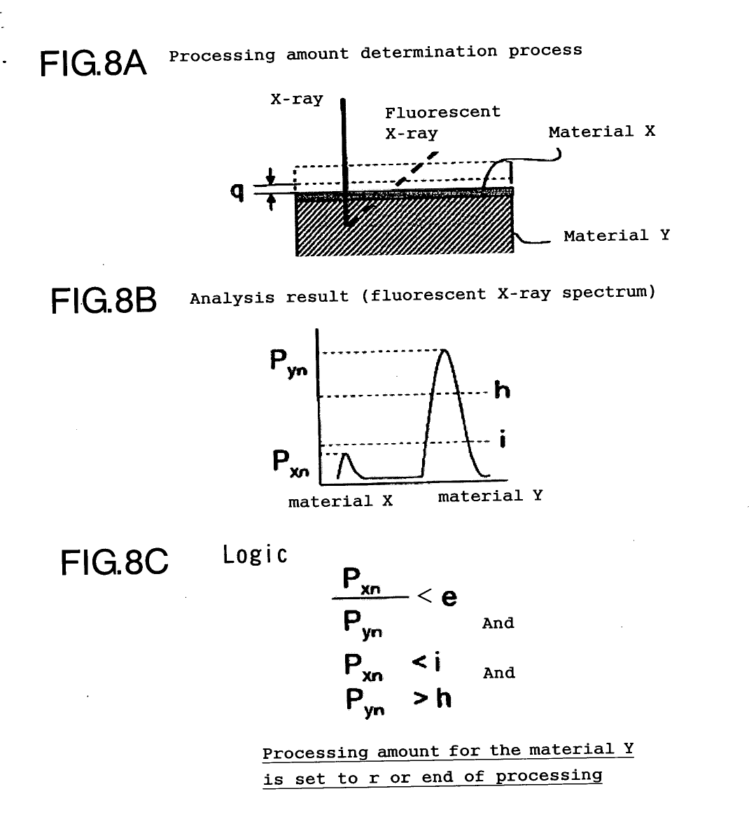

Then, when a state as shown in FIG. 8A is obtained, the fluorescent X-ray spectrum shown in FIG. 8B is obtained to satisfy the logic as shown in FIG. 8C. When both of the logics shown in FIGS. 8B and 8C are satisfied, a processing amount r can be estimated. It is possible to end the processing for analyzing the material Y and end the analysis operation, depending on the value of the processing amount r. That is, when analyzed intensity peak Pxn of the component of the material X is lower than specified value i and analyzed intensity peak Pyn of the component of the material Y is higher than specified value h, it is determined that the thickness of the material X becomes substantially 0 value to determine shift to a processing step in which the processing amount for the material Y is set to r, or end of the processing.

Note that the above specified values g, h and i are previously set in consideration of the component elements to be measured and the theoretical intensity of a fluorescent X-ray for the component elements (theoretical value in consideration of an X-ray transmittance). In the respective logics, g is higher than i, and the set values of g and h are independent values. The value of g may become higher than that of h, in some cases.

As described above, in the case of multi-layer (two layers, in this example), based on the ratio between the intensities of the fluorescent X-ray spectrum obtained from the respective material layers and comparison between the intensities and respective specified values, it is possible to determine a predetermined processing amount set in advance and estimate the subsequent processing amount. Note that the sample with two layers is used in this example. However, even in the case where a sample with three layers or more is used, it is possible to estimate the processing amount more finely by forming logics and applying them. Further, as another method of estimating the processing amount, it is possible to estimate the subsequent processing amount by comparing the analysis results before and after the processing and comparing the compared result with a predetermined criterion.

As in the case of the determination based on the image, the above determination operation is set to the analysis menu depending on the sample to be analyzed, and the controller 7 repeats the determination according to the analysis menu to automatically perform the analysis and processing number of times.

(Combination)

The abovementioned estimations based on the image and analysis result can be combined. For example, when analysis of LN layer shown in FIG. 5 is performed, processing up to LN-1 layer is performed based on a pattern matching using an image and, after that, a finer estimation of the processing amount is performed based on the analysis result as shown in FIG. 6.

In the manner as described above, the controller 7 determines whether to estimate the processing amount based on the image (Yes in step S11) or on the analysis result (No in step S11) (Yes in step 15). When performing the determination (estimation) based on the image, the controller 7 allows the imaging section to perform pattern imaging (step S12) and matching between the pattern and the known pattern (CAD data or already acquired imaging pattern) (step S13) to estimate the processing amount or processing position (step S14).

When performing the determination based on the analysis result (Yes in step S15), the controller 7 determines whether a predetermined logic is satisfied or not to estimate the subsequent processing amount (step S16).

The controller 7 ends the processing in step S14 or step S16. On the other hand, when ending the analysis, the controller 7 advances to step S17 with the determination in the analysis and gives an end instruction to step S5 (step S17).

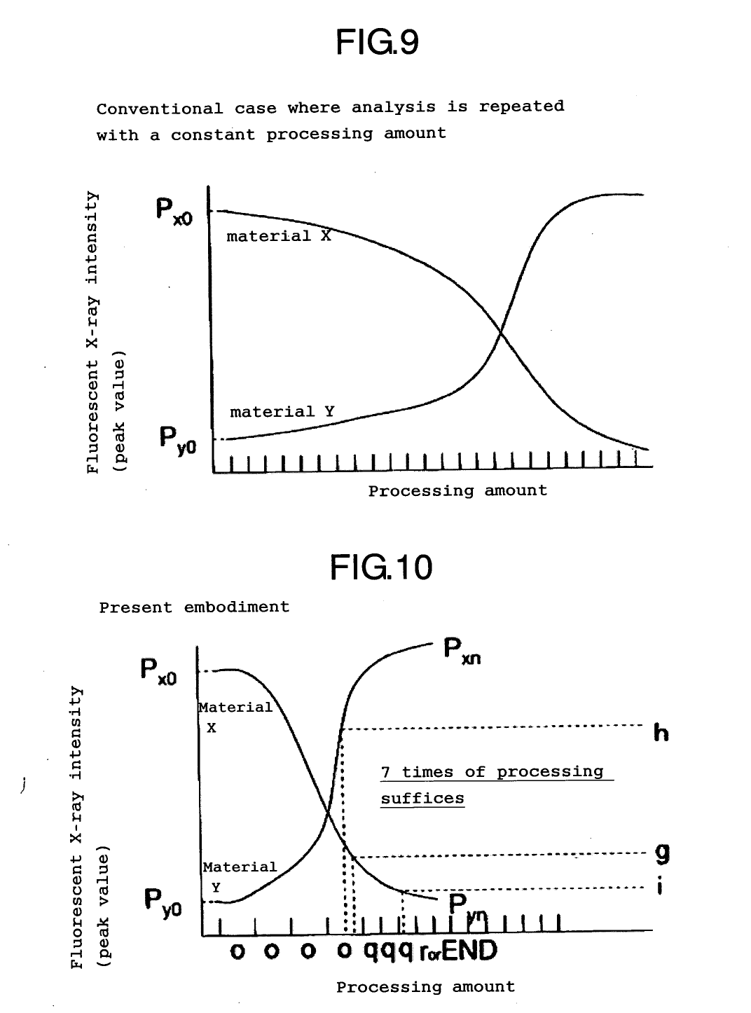

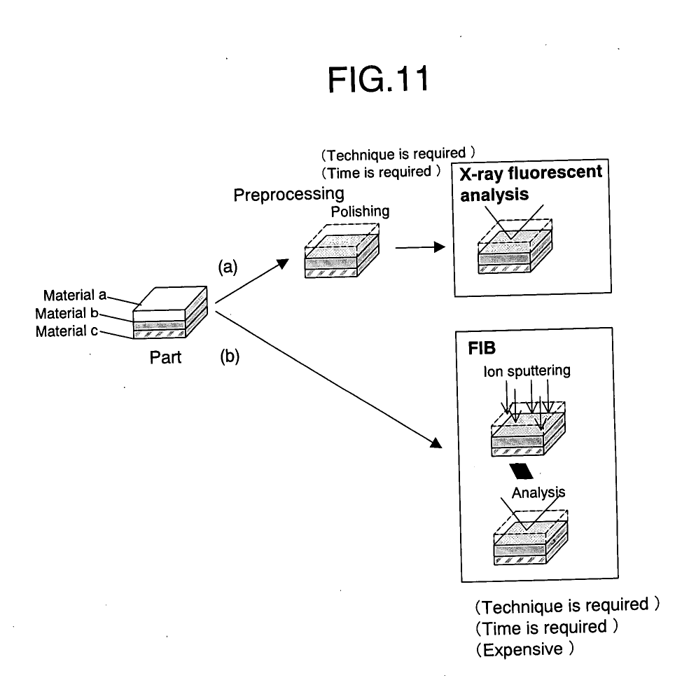

Effects obtained by estimating the processing amount as described above in the embodiment of the present invention will be described with reference to FIGS. 9 and 10.

FIG. 9 shows a conventional technique, and estimation cannot be made in this technique. Accordingly, in the case where a part having an unknown structure is analyzed, or processing is performed while the feedback of the processing amount is carried out, a large number of the processing amounts need to be set at a certain level of fineness. Therefore, the number of times of the processing to be performed becomes large to prolong the analysis time, as well as to result in a large amount of labor.

On the other hand, in the embodiment of the present invention, the processing amount can be estimated as shown in FIG. 10, so that the processing can be performed roughly at the initial stage to reduce the number of times of the processing to be performed, thereby enabling quick and effective analysis.

Note that g, h, and i shown in FIG. 10 correspond to the counterparts shown in FIGS. 6 to 8.

As described above, according to the present invention, it is possible to successively perform a sample feeding, processing, and analysis to thereby realize significant time reduction, as compared to the conventional case where the processing and analysis are individually performed. Further, a control program that can determine any of the known part structure information, actual image pattern obtained from an image recognition device, quantitative analysis result obtained from an analyzer, qualitative analysis amount obtained from an analyzer according to a predetermined criterion and can designate, process, and analyze the object to be analyzed automatically or arbitrarily is used to perform the processes described above, thereby realizing significant time reduction while eliminating a need of an advanced processing technique.

In particular, it is possible to estimate the subsequent processing amount based on the X-ray transmittance estimated from the X-ray irradiation intensity and area, composition of the sample material, and sample film thickness, and the actually measured X-ray intensity, thereby improving efficiency of the analysis operation.

When the above steps shown in FIGS. 2 and 3 are stored in a computer-readable storage medium as a fluorescent X-ray analysis program, it is possible to allow a fluorescent X-ray analyzer to perform automatic analysis. The computer-readable storage medium mentioned here includes: a portable storage medium such as a CD-ROM, a flexible disk, a DVD disk, a magneto-optical disk, or an IC card; a database that holds computer program; another computer and database thereof; and a transmission medium on a network line.

What is claimed is:

1. A fluorescent X-ray analyzer that performs analysis of materials in a sample including different materials in the form of a multiple layer, comprising:
a processing section that applies processing to the sample;
an analysis section that analyzes the materials by irradiating the sample with an X-ray to detect a fluorescent X-ray;
a controller that estimates a processing amount for the sample based on an analysis result obtained by the analysis section and allows the processing section to apply processing to the sample based on the estimated processing amount.

2. The fluorescent X-ray analyzer according to claim 1, wherein
the controller detects fluorescent X-rays obtained at least from two layers stacked in the depth direction of the sample and estimates the processing amount based on the intensities of the detected fluorescent X-rays.

3. The fluorescent X-ray analyzer according to claim 1, further comprising
an imaging section that takes an image of the sample, wherein
the controller determines the processing amount for the sample or processing position in the sample based on the image taken by the imaging section.

4. The fluorescent X-ray analyzer according to claim 1, wherein
the controller compares the sample images obtained before and after the processing for the sample to be processed by the processing section and determines the processing amount for the sample or processing position in the sample based on the comparison result.

5. The fluorescent X-ray analyzer according to claim 3, wherein
the controller acquires structure information related to the sample, compares the structure information and image taken by the imaging section, and determines the processing amount for the sample or processing position in the sample based on the comparison result.

6. The fluorescent X-ray analyzer according to claim 1, wherein
the processing section includes a support section that supports the sample in a movable manner, and
the controller allows the support section to move the sample when the processing section performs processing.

7. A fluorescent X-ray analysis method that performs analysis of materials in a sample including different materials in the form of a multiple layer, comprising:
an analysis step that analyzes the materials by irradiating the sample with an X-ray to detect a fluorescent X-ray;
a processing amount estimation step that estimates a processing amount for the sample based on an analysis result obtained in the analysis step; and
a processing step that applies processing to the sample based on the processing amount estimated in the processing amount estimation step.

8. The fluorescent X-ray analysis method according to claim 7, wherein
the estimation step estimates the processing amount based on the intensities of the fluorescent X-rays obtained at least from two layers stacked in the depth direction of the sample.

9. The fluorescent X-ray analysis method according to claim 7, further comprising:
an imaging step that takes an image of the sample; and
a determination step that determines the processing amount for the sample or processing position in the sample based on the image taken by the imaging step.

10. The fluorescent X-ray analysis method according to claim 9, wherein
the determination step compares the sample images obtained before and after the processing for the sample to be processed in the processing step and determines the processing amount for the sample or processing position in the sample based on the comparison result.

11. The fluorescent X-ray analysis method according to claim 9, wherein
the determination step acquires structure information related to the sample, compares the structure information and image taken in the imaging step, and determines the processing amount for the sample or processing position in the sample based on the comparison result.

12. A fluorescent X-ray analysis program allowing a computer to execute a fluorescent X-ray analysis method that performs analysis of materials in a sample including different materials in the form of a multiple layer, the program allowing the computer to execute:
an analysis step that analyzes the materials by irradiating the sample with an X-ray to detect a fluorescent X-ray;
a processing amount estimation step that estimates a processing amount for the sample based on an analysis result obtained in the analysis step; and
a processing step that applies processing to the sample based on the processing amount estimated in the processing amount estimation step.

13. The fluorescent X-ray analysis program according to claim 12, wherein
the estimation step estimates the processing amount based on the intensities of the fluorescent X-rays obtained at least from two layers stacked in the depth direction of the sample.

14. The fluorescent X-ray analysis program according to claim 12, further allowing the computer to execute:
an imaging step that takes an image of the sample; and
a determination step that determines the processing amount for the sample or processing position in the sample based on the image taken by the imaging step.

15. The fluorescent X-ray analysis program according to claim 14, wherein
the determination step compares the sample images obtained before and after the processing for the sample to be processed in the processing step and determines the processing amount for the sample or processing position in the sample based on the comparison result.

16. The fluorescent X-ray analysis program according to claim 14, wherein
the determination step acquires structure information related to the sample, compares the structure information and image taken in the imaging step, and determines the processing amount for the sample or processing position in the sample based on the comparison result.
